(19) United States
(12) Patent Application Publication
(10) Pub. No.: US 2008/0251573 A1
(43) Pub. Date: Oct. 16, 2008

(54) One Piece Container with Hinged Cap/Lid

(75) Inventors: Roger Nobilet, Chelles (FR); Didier Lancesseur, Boulogne (FR)

Correspondence Address: DENNISON, SCHULTZ & MACDONALD, 1727 KING STREET, SUITE 105, ALEXANDRIA, VA, 22314, US

(73) Assignee: AIRSEC, Choisy le Roi (FR)

(21) Appl. No.: 12/066,775

(22) PCT Filed: Sep. 25, 2006
(86) PCT No.: PCT/FR06/02188

§ 371 Date: May 7, 2008

(30) Foreign Application Priority Data
Sep. 23, 2005 (FR) 0509770

(51) Int. Cl. B65D 5/00; B31B 1/90

(52) U.S. Cl. 229/146; 493/104

(57) ABSTRACT

A container for packaging products includes an envelope formed by a skirt extending over the entire length of the body of the container, where the base is open prior to being filled, a reversible closable closure such as a cap or lid having a hinge linking the reversible closure to the envelope, optional tamperproof means, optional child-resistant opening means, and means for closing the open end of the envelope. The container includes a device for controlling its internal atmosphere.

### FIELD OF THE INVENTION

The invention relates to a one-piece container for packaging products with a base and a cap/lid including a device for controlling the internal atmosphere, which is filled via the base before the base is permanently closed.

The invention relates to a one-piece container for packaging on machines running at high-speed, for products to be packaged such as, for example, pharmaceutical, cosmetic, food, veterinary or diagnostic products in any solid form and needing to be supplied via the base, due to the fact that said products are preferably provided, by the packaging machine, in the form of a prearranged stack that should not be broken.

More specifically, the invention relates to a container including a re-closable cap/lid with an integral hinge, including a device for controlling its internal atmosphere, with a child safety device and a tamper evidence means.

### PRIOR ART

Numerous containers comprising an attached base are described in the technical literature, in particular in that constituted by patent applications and/or published patents.

Among these documents, one of them has been used: this document (DE 3519296) describes a container for test tab-type diagnostic products that are sensitive to moisture. Such a container with a rectangular cross-section with rounded sides comprises an open end for receiving an attached base and a partially open end for receiving a lid with an integral hinge, which lid is adjusted to the shape of said end of the oblong container body and is mounted by clipage on said end so as to be capable of closing the opening thereof.

The base tightly attached to the open end of the container, after filling thereof, is equipped with a drying device. The container does not have a first-opening evidence means and does not have a device making it difficult for children to open it.

Such a container does not satisfy all of the current requirements of use, in particular safety requirements.

Moreover, such a container must be produced in two operations, an operation of injection moulding of the container body and an operation of injection moulding of the cap with an integral hinge with its means for clipage on the container body. Such a container production is thus very restrictive in terms of automation. It requires two moulds and a separate assembly of the two parts moulded independently of the final closure of the base. Such a container cannot satisfy the current mass-production and cost-cutting requirements.

### SUMMARY OF THE INVENTION

A problem to be solved is that of producing a container offering the usage functions to which a user is accustomed, i.e. a container:

a) provided with:
reversible closure means of the re-closable hinged cap/lid-type making it possible to re-close the container after a tablet has been taken, and before the next one is taken, protecting the contents between two openings and thus making it possible, if means for controlling the internal atmosphere of the container are present, for said means to act, for example, by absorbing an excess of moisture;
means for controlling the internal atmosphere of the container, in particular in the case of products sensitive to moisture;
optionally a tamper evidence means, thus enabling each end user to verify the physical integrity of the container and therefore of its contents when the container is first opened, this tamper evidence means is destroyed upon first opening so that the contents can be accessed, then removed, and thus providing evidence that the container has been opened;
optionally childproof safety means, so as to significantly limit the risks associated with an opening of the container, in particular of pharmaceutical products, by a child not capable of understanding the potential danger of the drugs thus accessed;

b) while providing, during the filling step, the possibility of handling, and more specifically of easily inserting into the container, the products to be packaged, when said products are provided in a stack. Such stacks with predetermined numbers of tablets have the advantage of making it possible to maximize the number of tablets in the given volume of the container, better than what could be obtained with bulk insertions. In addition, such a stack insertion prevents the risks of mechanical deterioration by friction and abrasion, for potentially friable products. Indeed, friable products would not withstand high-speed bulk insertion into a container, if the insertion had to be done by a feed shoot, for example, through an opening positioned at the top of the container, as is the case in conventional filling installations, with containers of the prior art;

c) and of enabling, with a closure means, the automatic and final closure of the open base of the container, with the largest possible dimension, that was used for the filling, when the container has effectively been filled.

The invention is thus intended to respond to the problems raised for the designer and to overcome all or some of the disadvantages mentioned above, and thus constitute a significant improvement with respect to the prior art.

Thus, the invention relates to a container for packaging products including:
(i) a casing formed by a skirt extending over the entire height of the body of said container, of which the base is open before filling, (ii) reversible closure means of the closable cap-lid type with a hinge connecting the reversible closure means to the casing, (iii) optionally a tamper evidence means, (iv) optionally childproof safety means, (v) and means for closing the open end of the casing;
and is characterized in that said container includes a device for controlling the internal atmosphere.

Another object of the invention is the use of the container for packaging products to be packaged, more specifically of the pharmaceutical, cosmetic, food, veterinary or diagnostic type, which may or may not be sensitive and require specific protection from the external environment, for example protection against moisture.

### DETAILED DESCRIPTION OF THE INVENTION

The one-piece assembly formed by the casing of the container, the reversible hinged closure means, the optional tamper evidence means, and the optional childproof safety means according to the invention, is produced by techniques of injection moulding thermoplastic materials, and integrates, in a single piece, all of the conventional functions of a container, in particular a pharmaceutical container. In addition, it very specifically comprises a skirt forming the container body and extending over the entire height of the body of said container.

The one-piece assembly is thus equipped with reversible closure means of the cap/lid type, with an integral hinge, i.e. made of the same material as the elements that are connected by these connection means constituted by the hinge, between the re-closable cap/lid and the casing. Such an integral hinge can be designed so as to have a mechanism enabling it to pivot easily in only two positions, a so-called “wide opening” position and a so-called “closed” position, which mechanism is constituted by means for assisting the opening and closing of the cap/lid.

The one-piece assembly can also be equipped with tamperproof means, i.e. a first-opening evidence means. This first-opening evidence means is constituted by a membrane of which the planar shape is that of the cross-section of the upper end of the casing, such as, for example, the discharge aperture of the body of the container, which can be, for example, a neck. This membrane is connected, by its periphery, to the internal surface of the discharge aperture of the container body, closing the container in a completely tight manner in spite of the fact that the re-closable cap/lid can be opened. This thin membrane is connected by its periphery to the internal surface of the discharge aperture of the body of the container by means of a thinner, breakable area, which can thus easily be torn when a tearing force is exerted, by the first user, by pulling means securely connected to this membrane, such as, for example, a gripping ring securely connected to the membrane. In this case, the user can put a finger in this gripping ring and tear the thin area of the membrane, thus freeing the aperture. This gripping ring is also injection moulded in a single operation and in one piece with the membrane, and therefore with the aforementioned one-piece assembly.

This membrane is positioned so that it is set back from the upper end of the aperture of the container body, thus leaving a space available for housing the gripping ring when the cap/lid is in the closed position. The design of the gripping ring can be such that the plane that it forms with the plane of the membrane enables easy insertion of the end user's finger. A certain elasticity of the materials optionally enables this gripping ring to return by elasticity to a plane forming an angle of around 45° with the plane formed by the membrane, if it was crushed by the cap/lid when the latter was closed.

The one-piece assembly can also include childproof safety means, so as to significantly limit the risks associated with a possible opening of the container. These means are a device that consists of a lug located on the external periphery of the aperture of the container body, in a position diametrically opposite the hinge and being housed in a suitable recess provided for this purpose on the re-closable cap/lid. However, such a lug can be engaged in its recess only insofar as said re-closable cap/lid has a certain capacity to be deformed under the effect of two opposite pressure forces, exerted by the user in a diametrical plane perpendicular to the plane formed by the lug and the hinge, which planes both pass through the axis of the container, thus forcing the external cylinder constituting the cap/lid to take on an oval shape, and therefore to increase its diametrical dimension, and thus release the lug from its recess.

To perfectly position this diametrical pressure, created by two fingers of the hand, two areas having a surface roughness have been created on the external face of the cap/lid. These areas having a surface roughness, indicating the two pressure points, can be constituted, for example, by grooves or by any other means such as a surface portion with increased mattness, making it possible simultaneously to identify the position of the fingers and to limit the sliding effect of the fingers on the cap/lid.

The cap/lid comprises a projecting tab that allows to exert an upward pressure on the hinged cap/lid, thus causing it to open by pivoting.

The cap/lid and the casing of the container also comprise means making it possible to achieve good tightness between the aperture of the container and the cap/lid when it is closed, once the first-opening evidence membrane has been torn and removed. The means for creating this good tightness include:
in the cap/lid, an internal cylindrical wall coaxial to said cap/lid of the male type, having means for positioning when the cap/lid is closed, such as a chamfer,
in the extension of the casing and above the tamper evidence means, a cylindrical wall of the female type.

These male and female cylindrical walls are adjusted to one another when the cap/lid is closed so as to create the tightness of the container, once it is being used.

The one-piece assembly comprises in particular a skirt with a length so that it forms the container body.

This skirt may have a cylindrical or elliptical or polygonal cross-section. To facilitate the equipment production, it is preferably cylindrical.

This skirt has a sizeable opening in terms of cross-section, generally larger than the cross-section of the products to be packaged, thus enabling mechanical systems, for example with pistons, available on the packaging machines, to very precisely position a stack of products to be packaged inside the skirt forming the container body, even though bulk filling remains possible. The open end of the skirt is then permanently closed by an attached end once the container has been filled.

The skirt, forming the container body, has, at its open end, at least one means for irreversible connection with the attached closure base. These irreversible connection means can be press fitting, which makes it possible in particular to assemble the attached base to the skirt by a simple pressure, with a ring system that is fitted into a groove. The ring and groove system is positioned in the internal end of the open skirt of the casing and on the external periphery of the attached base. A certain elasticity and adjustment of the stiffness of the materials constituting the one-piece assembly and the base makes it possible to securely assemble such an assembly.

Welding or bonding may also be considered according to requirements. Preferably, the assembly is performed by adjusted press-fitting or snap-fitting between the ring and groove. This assembly between the attached base and the open end of the skirt is also tight.

The means for controlling the internal atmosphere of the container can be of the porous capsule type, containing an absorbent product or a monolithic absorber, i.e. made of a polymer material matrix receiving absorbent inorganic materials or specific polymers having an affinity for the gaseous pollutant present in situ.

When the means for controlling the internal atmosphere of the container is of the porous capsule type, this capsule may contain at least one of the dehydrating agents selected from the group consisting of silica gel, dehydrating clay, activated alumina, calcium oxide, barium oxide, natural or synthetic zeolites, molecular sieve or the like, or deliquescent salts such as magnesium sulfate, calcium chloride, aluminum chloride, lithium chloride, calcium bromide, zinc chloride or the like.

Said capsule may be placed in the base of the container or in the reversible closure means or in both.

When the means for controlling the internal atmosphere of the container are of the monolithic absorber type, this absorber can be an insert, for example, a dehydrating insert, which has a shape identical to that of said skirt and is inserted therein, and preferably has a cylindrical shape. Such an insert is then positioned according to a lining inside the skirt forming a container. Its external surface may be adjusted, by close contact, with the entire internal surface of the skirt or optionally come into contact with longitudinal ribs on the internal surface of the skirt.

This dehydrating element positioned in a circumferential cylindrical lining can also be produced by bi-material co-injection with said one-piece assembly.

This monolithic absorber-type insert or this internal coating constituting the means for controlling the internal atmosphere of the container may be produced by a combination of the same thermoplastic polymers or copolymers as those used to produce the one-piece assembly and the attached base, with at least one dehydrating agent, mentioned above in the list concerning the production of dehydrating capsules, in a specific compounding operation.

The casing, the cap/lid with an integrated hinge, the tamper evidence means, and the childproof safety means are injection moulded in a single operation, and constitute the one-piece assembly made of a single material. In addition, the injected cap/lid may be closed when the mould is opened after injection and thus produce a complete assembly ready to be sent to the packager.

The one-piece assembly is injected in a configuration corresponding to the “wide open” position of the cap/lid, so as to facilitate the mould production and stripping. Nevertheless, when the one-piece assembly is automatically removed from the mould, the cap/lid is pivoted, by mechanical movement, to another configuration corresponding to the “closed” position, without any external intervention.

A person skilled in the art will appreciate the enormous increase in productivity of such a design with substantially integrated functions.

The polymer materials desirable for producing the one-piece assembly and the base of the container are generally and not exclusively selected from the group of materials consisting of thermoplastic polymers, including in particular polyolefins, such as polyethylenes, polypropylenes, ethylene/propylene copolymers and mixtures thereof, polyamides (PA), polystyrenes (PS), acrylonitrile-butadiene-styrene (ABS) copolymers, styrene-acrylonitrile (SAN) copolymers, polymethyl methacrylates (PMMA), polyethylene terephthalates (PET), polybutylene terephthalates (PBT), polyacetals (POM), polyvinyl chlorides (PVC) and polycarbonates (PC).

Mono-olefin elastomers, such as, for example, polymers of isobutylene/isoprene, ethylene-vinyl acetate (EVA), ethylene-propylene (EPR), ethylene-propylene-diene (EPDM), acrylic ethylene-esters (EMA-EEA), fluorinated polymers, diolefin rubbers, such as, for example, polybutadiene, butadiene-styrene (SBR) copolymers, rubbers based on condensation products such as, for example, polyester and polyurethane thermoplastic rubbers, silicones, styrene rubbers, such as styrene-butadiene-styrene (SBS), styrene-isoprene-styrene (SIS), styrene-ethylene butadiene styrene (SEBS) and other block copolymers, implemented alone or in a mixture, formulated or not, can also be used.

Nanometric inorganic fillers such as lamellar clays may be combined with the polymer materials listed above, in compounding operations. Such inorganic fillers are preferably clays and are selected from the group of smectites, consisting of monmorillonite, nontronite, beidellite, volkonskoite, hectorite, saponite, sanconite, magadiite, and kenyaite, the vermiculite group, and the group of illites such as ledikite. These clays have constitutive lamellar surfaces with a capacity to exchange ions with an organo-ionic compound to which they are exposed for the purpose of exfoliation, so as to form nanometer-sized inorganic elements that are fully dispersible in the thermoplastic polymer matrix, without re-agglomeration during production of the compound. These fillers have been previously treated by any known technique, for example a cationic technique, so as to activate a first separation of the laminae and possibly a capacity for bonding of functionalized groups of the chain of a compatibilizing agent when present. These particles of nanometric size forming lamellar layers have a capacity to increase the path of gaseous molecules passing through the thermoplastic matrix and thus make it possible to produce materials with improved barrier properties. Other well-known additives of the prior art, such as micrometric inorganic fillers, for example, calcium carbonates, pigments and dyes, stabilizers and lubricants may be added to the polymer materials cited above.

Specific polymer materials such as so-called barrier resins, i.e. having high barrier properties to gases, including water vapor, oxygen and carbon gas as well as other gaseous pollutants present in the atmosphere, of the polyvinyl ethylene-alcohol (EVOH) type or of the modified polyamide type, may be, in part, used to produce the container according to the invention. These resins are then combined with the polymer materials described above, and constitute the structure of the container, in the form of an internal barrier layer encapsulated between two layers of structural polymer materials. These so-called barrier resins of the polyvinyl ethylene-alcohol (EVOH) or modified polyamide type are combined with the thermoplastic polymer compositions in a multi-layer structure. Such multi-layer constructions are obtained by any multi-material co-injection technique, sequential or other, well known from the prior art in the field of plastic processing.

Such so-called barrier resins may also be formulated so as to modify the absorption or adhesion properties.

Polyolefins, and in particular polypropylenes, are preferably selected to form the container structure because such polymer materials have an excellent capacity for developing integral hinges, while combining a certain stiffness and resilience. They are also easy to mould.

The invention can be better understood in view of the following numbered description of the figures, which are provided solely for illustrative and non-limiting purposes, of a particular drying container of the invention.

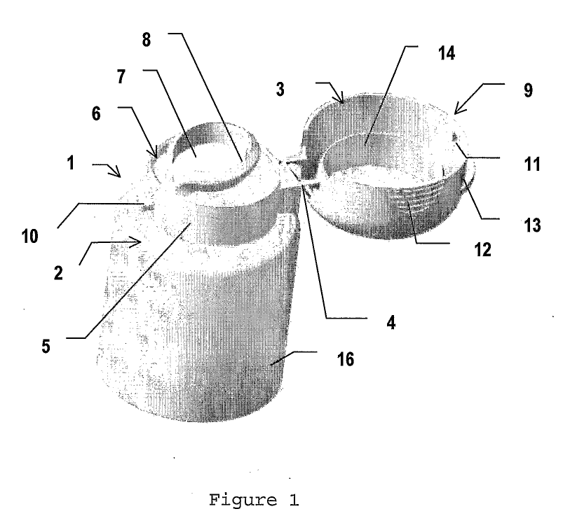

FIG. 1 shows a perspective view of a container with its hinged cap/lid in the open position;

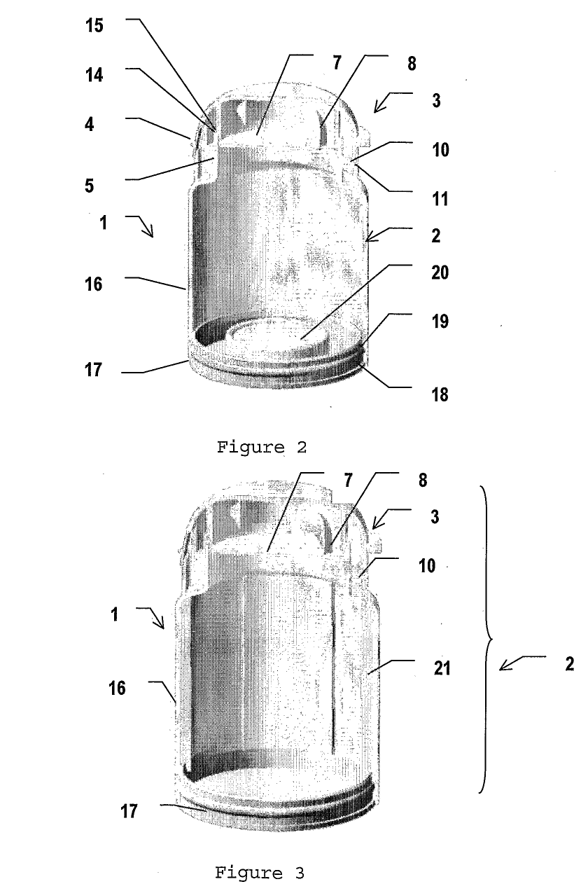

FIG. 2 shows a cross-section and perspective view of the container according to the invention, making it possible to observe the closure forming a casing with its cap/lid in the closed position and the associated base, in a configuration deploying, at the level of the base, a dehydrating device;

FIG. 3 shows a cross-section and perspective view of the container according to the invention, making it possible to observe the closure forming a casing with its cap/lid in the closed position and the associated base, in a configuration deploying a dehydrating device in the form of an insert fitting in the inside of the skirt of the closure forming the container body.

FIG. 1 shows a perspective view of the container (1) according to the invention. This container is constituted by a closure forming a casing (2) and an attached base (17) closing the casing of the container body.

The closure forming a casing (2) is provided with reversible closure means of the re-closable cap/lid type (3) with an integral hinge (4), connecting the re-closable cap/lid (3) to the support constituted by the neck (5) of the container body.

The assembly of the closure forming a casing (2) is also provided with a tamper evidence means or first-opening evidence means (6). This first-opening evidence means (6) is constituted by a membrane (7) that is tearable, or frangible, capable of being removed by a pulling force exerted by the first user, for example, by pulling on a gripping ring (8) securely connected to the membrane.

The assembly of the closure forming a casing (2) is also provided with a childproof safety device (9). This device consists of a lug (10) located on the external periphery of the neck of the container body, in a position diametrically opposite the hinge and being housed in a suitable recess (11) provided for this purpose on the re-closable cap/lid (3). Two areas of surface roughness (12) indicate the two pressure points enabling to ovalize the cap/lid shape and to release the lug from its recess.

The cap/lid (3) comprises a projecting tab (13) that facilitates its opening with a movement exerted upward causing the cap/lid (3) to pivot about its hinge (4).

The good tightness between the neck (5) of the container body and the cap/lid is ensured by a male cylinder (14) present on the mobile internal part of the cap/lid fitting in the female part constituted by the container neck (15).

The closure assembly comprises in particular a skirt (16) with a length so that it forms the body of the container. The open end of the skirt (16) is permanently closed by a base (17) once the container (1) has been filled.

This skirt, which forms the casing body of the container, has, at its end, at least one means for irreversible connection with the closure base. These irreversible connection means can be press fitting, which makes it possible in particular to assemble the base to the skirt by a simple pressure, with a ring system (18) that is fitted into a groove (19), so as to achieve a tight assembly that is easy to implement.

FIG. 2 shows a cross-section and perspective view of the container (1) according to the invention, making it possible to observe the closure forming a casing (2) with its cap/lid (3) in the closed position and the associated base (17), in a configuration deploying, at the level of the base, a dehydrating device (20).

FIG. 3 shows a cross-section and perspective view of the container (1) according to the invention, making it possible to observe the closure forming a casing (2) with its cap/lid (3) in the closed position and the associated base (17), in a configuration deploying a dehydrating device in the form of an insert (21) fitting in the skirt of the closure forming the container body.

1. One-piece container (1) for packaging products, including:
(i) a casing (2) formed by a skirt (16) extending over the entire height of the body of said container, of which the base is open before filling,
(ii) reversible closure means of the closable cap-lid type (3) with a hinge (4) connecting said reversible closure means (3) to the casing (2),
(iii) tightness means (14, 15) between the neck (5) of the container and the closure means (3),
(iv) a tamper evidence means (6),
(v) childproof safety means (9),
(vi) means for closing the open end of the casing (2),
(vii) a device for controlling its internal atmosphere (20),
characterized in that:
a) the hinge (4) of the closure means (3) connecting said closure means (3) to the casing (2) is integral and is provided with means for assisting the opening and closing of the cap/lid (3),
b) the tamper evidence means (6) is constituted of a tearable membrane (7) having a planar shape and connected, by its periphery, to the internal surface of the container (1), via a frangible area,
c) the tightness means (14, 15) include a cylindrical wall of the female type (15) located in the extension of the casing, above the tamper evidence means (6) and a cylindrical wall of the male type coaxial and internal to said closure means (3), adjusted to said female-type wall (15) by closing the closure means (3),
d) the childproof safety means (9) is a device comprising a lug (10) located on the external wall of the neck (5) of the container body, and a recess (11) for receiving said lug (10), and located on the closure means (3).

2. Container according to claim 1, characterized in that the hinge (4) of the reversible closure means (3) of the re-closable cap/lid type is of the type having two predefined, so called “wide open” or “closed”, positions.

3. Container (1) according to claim 1, characterized in that the reversible closure means (3) of the re-closable cap/lid has a capacity to be deformed under the effect of two opposite pressure forces, exerted by the user in a diametrical plane perpendicular to the plane formed by the lug (10) and the hinge (4), which planes both pass through the axis of the container (1).

4. Container (1) according to claim 3, characterized in that the closure means (3) comprises on its external face two areas of surface roughness (12).

5. Container (1) according to claim 4, characterized in that the two areas of surface roughness are made of grooves or of surface portions having an greater mattness than the other portions of the closure means (3).

6. Container (1) according to claim 1, characterized in that the tearable membrane (7) of the tamper evidence means is provided with pulling means (8) securely connected to the membrane (7).

7. Container (1) according to claim 6, characterized in that the pulling means (8) are of the gripping ring (8) type securely connected to said membrane (7).

8. Container (1) according to claim 7, characterized in that the gripping ring (8) is injection moulded in a single operation and forms a single piece with the membrane (7).

9. Container (1) according to claim 1, characterized in that the internal cylindrical wall coaxial to said closure means (3) of the male type (14) comprises positioning means of the chamfer type.

10. Container (1) according to claim 1, characterized in that the device for controlling the internal atmosphere (20) is preferably a dehydrating agent.

11. Container (1) according to claim 1, characterized in that the device for controlling the internal atmosphere (20) of the container is of the porous capsule type, containing an absorbent product or a monolithic absorber.

12. Container (1) according to claim 1, characterized in that when the device for controlling the internal atmosphere of the container (1) is of the porous capsule type containing a absorbent product, said capsule is placed in the attached base of said container (1) or in the reversible closure means (3) or in both.

13. Container (1) according to claim 1, characterized in that when the device for controlling the internal atmosphere (20) of the container is of the porous capsule type, containing an absorbent product, said capsule contains at least one of the dehydrating agents selected from the group consisting of silica gel, dehydrating clay, activated alumina, calcium oxide, barium oxide, natural or synthetic zeolites, molecular sieve or the like, or deliquescent salts such as magnesium sulfate, calcium chloride, aluminum chloride, lithium chloride, calcium bromide, zinc chloride or the like.

14. Container (1) for packaging products according to claim 1, characterized in that, when the device for controlling the internal atmosphere (20) of the container is of the monolithic insert type, said insert is fitted inside the skirt of the container.

15. Container (1) according to claim 1, characterized in that, when the device for controlling the internal atmosphere of the container (1) is of the monolithic insert type, said insert is co-injected by bi-material injection techniques at the same time as the one-piece container (1) including the skirt (16), the reversible closure means (3) of the re-closable hinged cap/lid type, the tamper evidence means (6) and the safety device (9).

16. Container (1) according to claim 1, characterized in that, when the device for controlling the internal atmosphere of the container is of the monolithic insert type, said insert is produced by a combination of at least one thermoplastic polymer selected from the group consisting of polyethylenes (PE), polypropylenes (PP), ethylene/propylene copolymers and mixtures thereof, polyamides (PA), polystyrenes (PS), acrylonitrile-butadiene-styrene (ABS) copolymers, styrene-acrylonitrile (SAN) copolymers, polyvinyl chlorides (PVC), polycarbonates (PC), polymethyl methacrylates (PMMA), polyethylene terephthalates (PET), polybutylene terephthalates (PBT), polyacetals (POM), and at least one dehydrating agent selected from the group consisting of silica gel, dehydrating clay, activated alumina, calcium oxide, barium oxide, natural or synthetic zeolites, molecular sieve or the like, or deliquescent salts such as magnesium sulfate, calcium chloride, aluminum chloride, lithium chloride, calcium bromide, zinc chloride or the like.

17. Container (1) according to claim 1, characterized in that the means for closing the open end of the casing (2) are an attached base (17).

18. Container (1) according to claim 17, characterized in that the attached base (17) is assembled to the open end of the casing by adjusted press fitting or snap fitting assembly.

19. Container (1) according to claim 18, characterized in that the adjusted press fitting or snap fitting assembly is performed by means of a ring and groove system positioned in the internal end of the open skirt (16) of the casing (2) and on the external periphery of the attached base (17).

20. Container (1) according to claim 17, characterized in that the attached base (17) is assembled to the open end of the casing (2) by welding.

21. Container (1) according to claim 17, characterized in that the attached base (17) is assembled to the open end of the casing (2) by bonding.

22. Container (1) according to claim 1, characterized in that the one-piece container (1) and the attached base (17) are produced by plastic processing methods using thermoplastic polymer compositions from the group consisting of polyethylenes (PE), polypropylenes (PP), ethylene/propylene copolymers and mixtures thereof, polyamides (PA), polystyrenes (PS), acrylonitrile-butadiene-styrene (ABS) copolymers, styrene-acrylonitrile (SAN) copolymers, polyvinyl chlorides (PVC), polycarbonates (PC), polymethyl methacrylates (PMMA), or polyethylene terephthalates (PET), implemented alone or in a mixture.

23. Container (1) according to claim 22, characterized in that the thermoplastic polymer compositions comprise nanometric inorganic fillers of the lamellar clay type.

24. Container (1) according to claim 22, characterized in that the so-called barrier resins of the ethylene-polyvinyl alcohol (EVOH) or modified polyamide type are combined with the thermoplastic polymer compositions in a multilayer structure.

25. Container (1) according to claim 1, characterized in that the one-piece container and the attached base of the container are produced by plastic processing methods and preferably by means of thermoplastic polymer compositions from the group consisting of polyethylenes (PE), polypropylenes (PP), ethylene/propylene copolymers and mixtures thereof.

26. Method for producing the container (1) according to claim 1, characterized in that the one-piece container (1) is injected into a configuration corresponding to the open position of the reversible closure means of the closable cap-lid type (3) and that, when the one-piece container is automatically removed from the mould, the reversible closure means of the closable cap-lid type (3) is pivoted by mechanical movement to another configuration corresponding to the closed position, without any external intervention.

27. (canceled)
